(19) United States
(12) Patent Application Publication
(10) Pub. No.: US 2012/0084200 A1
(43) Pub. Date: Apr. 5, 2012

(54) SYSTEMS AND METHODS FOR COMPLETING A FINANCIAL TRANSACTION

(76) Inventor: Michel Triana, Port Washington, NY (US)

(21) Appl. No.: 12/896,257

(22) Filed: Oct. 1, 2010

(51) Int. Cl. G06Q 40/00

(52) U.S. Cl. 705/39

(57) ABSTRACT

One example embodiment includes a method for increasing payment security during a financial transaction. The method includes identifying the buyer, where identifying the buyer includes confirming the buyer's identity, and issuing a one-time payment code to the buyer. The method also includes receiving the one-time payment code from a seller and authorizing payment to the seller.

### CROSS-REFERENCE TO RELATED APPLICATIONS

Not applicable.

### BACKGROUND OF THE INVENTION

Consumers and businesses engage in financial transactions millions of times every day. These transactions include purchases, wages for employment, business payments, loans, and many other types of transactions. These transactions can include many types of financial exchange, including cash, check, debit, credit cards, gift cards and other types of financial exchange. However, each type of financial exchange includes the need for the consumer to carry some form of payment, which leaves the consumer open to loss and fraud.

Consumer credit, in particular, has become a powerful tool in the marketplace. It allows consumers to purchase items that they otherwise would be unable to purchase. For example, the purchase price might be too large or the price might exceed the amount of cash carried by the consumer. It also allows for commerce on the Internet as consumers have a tool that allows them to purchase from a remote location and merchants have a tool to confirm payment before shipping the merchandise.

However, with the increase of credit availability, there has been a corresponding increase in fraud involving consumer credit. In particular, the instance of identity theft has skyrocketed as opportunistic criminals have taken advantage of the greatly increased number and options for credit cards. Identity thieves obtain personal or financial information from a consumer and then use it to steal funds or make purchases at the expense of the consumer. Identity theft is not limited to consumer credit but extends to other payment mechanisms such as check fraud and phishing scams that obtain consumers banking information. Indeed, virtually all existing payment mechanisms include an element of risk.

In particular, each time a transaction involving consumer credit takes place an opportunity exists for identity thieves to obtain the consumer's financial information. The transaction involves the exchange of financial information between the consumer and the merchant. The consumer presents financial information to the merchant who can then use the information to receive the necessary funds and complete the transaction.

The financial information involved can depend on the transaction type. It could include bank account numbers, credit card numbers, debit card numbers or any other type of financial information. All of this financial information includes a common characteristic. The information can be used for multiple transactions. E.g., a credit card number is not changed after it is used for a single transaction. Instead, the same credit card number can be used to complete multiple transactions. That means that during each transaction, there is a chance that the information could be intercepted and subjected to future fraudulent charges.

This presents a dilemma for both consumers and merchants. To reject consumer credit would severely limit opportunities for commerce but to allow consumer credit opens opportunities for identity theft. The consumer is forced to carry multiple types of payment mechanisms, such as credit cards, cash, checks, debit cards and gift cards. In addition to having the keep track of all of the different payment mechanisms, the consumer is subjected to increased fraud and inconvenience.

Accordingly, there is a need in the art for a system that can complete financial transactions without exchanging financial information. Additionally, there is a need in the art for a payment method that is convenient but that can be used only a single time. Further, there is a need in the art for a payment method that allows the user to make purchases without carrying any payment mechanism other that his/her identity. In addition, there is a need in the art for a payment method that is resistant to fraud and identity theft.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for increasing payment security during a financial transaction. The method includes identifying the buyer, where identifying the buyer includes confirming the buyer's identity, and issuing a one-time payment code to the buyer. The method also includes receiving the one-time payment code from a seller and authorizing payment to the seller.

Another example embodiment includes a system for increasing payment security during a financial transaction. The system includes a first hub, where the hub is configured to identify the buyer, and a code generator, where the code generator authorizes the payment and issues a one-time payment code to the first hub. The system also includes a second hub, where the second hub accepts the one-time payment code from the first hub and a payment engine, where the payment engine verifies the one-time payment code and authorizes payment.

Another example embodiment includes a method for increasing payment security during a financial transaction. The method includes confirming the identity of the buyer and determining whether the buyer has sufficient funds in a buyer account to cover the purchase amount. The method also includes issuing a one-time payment code to the buyer if the buyer has sufficient funds and transferring the one-time payment code to the seller. The method further includes confirming the authenticity of the one-time payment code. Confirming the authenticity of the one-time payment code includes determining whether the one-time payment code is a validly issued one-time payment code and determining whether the one-time payment code has expired. The method also includes transferring payment to the seller. Transferring funds to the seller includes crediting the purchase amount to the seller and debiting the purchase amount from the buyer.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating a secure payment system;

FIG. 2 illustrates a system for providing a one-time payment code;

FIG. 3 is a flow chart illustrating a secure payment method; and

FIG. 4 is a flow chart illustrating an alternative secure payment method.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

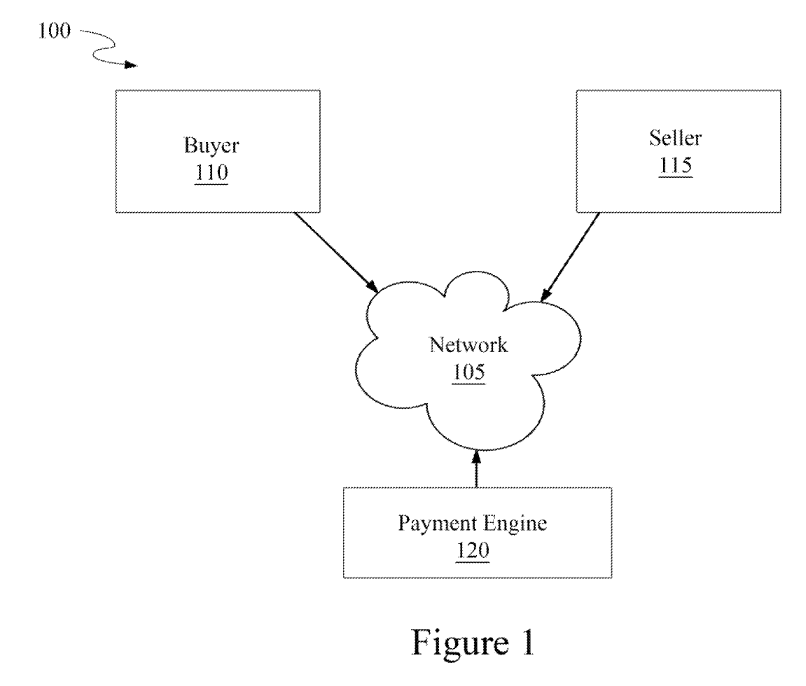

FIG. 1 is a block diagram illustrating a secure payment system 100. In at least one implementation, the secure payment system 100 can allow for a purchase to be completed without any exchange of payment information or money tender details. In particular, no financial information need be exchanged between different parties, other than a one-time payment code that is good for only the purchase amount and valid only for a limited time, as discussed below.

FIG. 1 shows that the system 100 can include a network 105. In at least one implementation, the network 105 can be used to connect the various parts of the system 100 to one another. The network 105 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 105 includes one or more cellular RF networks and/or one or more wired and/or wireless networks such as, but not limited to, 802.xx networks, Bluetooth access points, wireless access points, IP-based networks, or the like. The network 105 can also include servers that enable one type of network to interface with another type of network.

FIG. 1 also shows that the system 100 can include a buyer 110. In at least one implementation, the buyer 110 is any individual, corporation, organization, group or entity that wishes to make a purchase. In particular, the buyer 110 includes any prospective purchaser who has identified products, services or goods that are for sale and wishes to purchase the products, services or goods. For example, the buyer 110 can include a shopper wishing to make a purchase at a store. Additionally or alternatively, the buyer 110 could include a corporation entering into an agreement with a contractor. One of skill in the art will appreciate that the buyer 110 can include any entity wishing to exchange anything of value in return for products, services or goods.

FIG. 1 further shows that the system 100 can include a seller 115. In at least one implementation, the seller 115 is any individual, corporation, organization, group or entity that wishes to sell, vend or trade any products, services or goods in exchange for something of value. For example, the seller 115 can include a store, a website, an employee, a retailer or any other seller of products, services or goods. One of skill in the art will appreciate that the buyer 110 can include any entity configured to receive payment from a buyer 105.

FIG. 1 also shows that the system 100 can include a payment engine 120. In at least one implementation, the payment engine 120 transfers the funds for any necessary payment from the buyer 110 to the seller 115. In particular, the payment engine 120 transfers funds an account specified by the buyer 110 to an account specified by the seller 115. The payment occurs without the exchange of financial information between the buyer 110 and the seller 115, as discussed below. In at least one implementation, the buyer account and the seller account can include a savings account, a credit card, a debit account, a line of credit, a checking account or any other type of account.

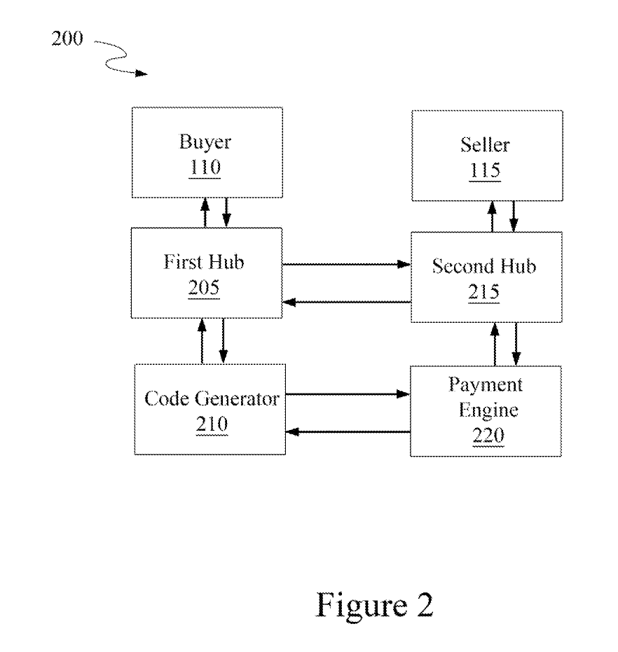

FIG. 2 illustrates a system 200 for providing a one-time payment code. In at least one implementation, the system 200 can allow a transaction between a buyer 110 and a seller 115 to be completed without any exchange of payment information or money tender details. In particular, no financial information need be exchanged between the buyer 110 and the seller 115, other than a one-time payment code that is good for only the purchase amount and valid only for a limited time, as discussed below.

FIG. 2 shows that the system 200 includes a first hub 205. In at least one implementation, the first hub 205 is configured to identify the buyer 110. In particular, the first hub 205 is configured to confirm the buyer's identity. For example, the first hub 205 can check the identity of the buyer 110 to prevent fraud or unauthorized transactions using the buyer's account. Confirming the buyer's identity can allow the buyer to complete a financial transaction without carrying payment mechanisms such as credit cards, checks, cash, debit cards, gift cards or any other payment mechanism. Additionally or alternatively, the first hub 205 can determine whether the buyer has sufficient funds in a buyer account to cover the purchase amount.

In at least one implementation, the buyer 110 can have different access rights to the buyer account. For example, the buyer 110 can be allowed to spend only a portion of the funds in a buyer account. Additionally or alternatively, the buyer 110 can have restricted access to the balance of spending statements of the buyer account. This can allow for gifts or transfers to the buyer while limiting the purchasing power of the buyers. In particular, allowances, expense accounts, gifts or other portions of a larger buyer account can be provided for spending by the buyer 110.

FIG. 2 shows that the first hub 205 can interact with the buyer 110. In at least one implementation, the first hub 205 can interact with the buyer 110 in order to confirm the buyer's identity. For example, the first hub 205 can confirm the buyer's identity through biometric identification. Biometric identification, or biometrics, comprises methods for uniquely recognizing individuals based upon one or more intrinsic physical or behavioral traits. Biometric characteristics can be divided in two main classes. Physiological biometrics are related to the shape of the body or various parts thereof. Examples include, but are not limited to, fingerprints, face recognition, DNA, palm print, hand geometry, iris recognition, retinal scans, and odor/scent. In contrast, behavioral biometrics are related to the behavior of a person. Examples include, but are not limited to, typing rhythm, gait, and voice recognition. Strictly speaking, voice is also a physiological trait because every person has a different vocal tract, but voice recognition is mainly based on the study of the way a person speaks and is, therefore, commonly classified as behavioral.

Additionally or alternatively, the first hub 205 can identify the buyer 110 using one or more implants or other devices placed internally or externally on the body of the buyer 110. For example, the identification can rely on bio-Implants, orthopedic implants, dental implants, brain Implants, extraocular implants or any other implant.

In at least one implementation, the first hub 205 can include a personal buyer hub. A personal buyer hub is one that is linked to an account of a single buyer 110. That is, a personal buyer hub is linked to a specific buyer account or accounts. For example, a personal buyer hub could include a user's cell phone, computer or other device used only by a single buyer 110 or group of buyers. As used in the specification and the claims, the term device shall include any artifact, apparatus, structure or gadget that is capable of performing the desired function, unless otherwise specified.

Additionally or alternatively, a personal buyer hub could include a secure website that the user can log into from any location. The personal buyer hub can also include a hub that can be used by a group of users. For example, a personal buyer hub can include a computer in a secure location that a corporation's employees can access, allowing select employees to make payments in behalf of the corporation.

In contrast, the first hub 205 can include a shared buyer hub. A shared buyer hub is one that can be used by more than one buyer. In at least one implementation, a shared buyer hub can be installed in or near a site maintained by the seller 115 to speed and facilitate transaction processing from multiple buyers. For example, a shared buyer hub can be located at the seller's place of business. The buyer 110 is authenticated on the shared buyer hub prior to a request for the transaction on the buyer's account.

FIG. 2 also shows that the system 200 can include a code generator 210. In at least one implementation, the code generator 210 issues a one-time payment code to the buyer 110. In particular, the one-time payment code can include a unique authorization code that can only be used once by the seller 115 to collect payment from the buyer 110. For example, after the one-time payment code is used it cannot be used again by the buyer 110 or by anyone else. Additionally or alternatively, the one-time payment code can be configured to expire after a certain amount of time after it issues if it has not been used during that time.

FIG. 2 shows that the code generator 210 can interact with the first hub 205. In particular, the first hub 205 can collect information used to identify the buyer 110 which is then sent to the code generator. For example, the first hub 205 can collect biometric data from the buyer 110 to be used by the code generator 210 to confirm the user's identity. Additionally or alternatively, the code generator 210 can issue the one-time payment code to the first hub 205.

FIG. 2 further shows that the system 200 includes a second hub 215. In at least one implementation, the second hub 215 includes a seller hub. A seller hub is a hub that is configured to request payment on behalf of the seller 115. In particular, the second hub 215 can transmit the amount due and the one-time payment code to ensure payment. The second hub 215 can include any device, apparatus or artifact meant to request payment. For example, the second hub 215 could include a cash register, either mechanical or digital, that submits an amount due for payment.

FIG. 2 shows that the second hub 215 can interact with the first hub 205. In at least one implementation, the first hub 205 can transmit the one-time payment code to the second hub 215. For example, the first hub 205 could broadcast the one-time payment code and the second hub 215 could receive the broadcast. The broadcast can occur over a network either wired or wireless. For example, the one-time payment code could be sent of a network, over the Internet, over a telephone network, sent in an email or SMS text message or could be broadcast in any other manner. Additionally or alternatively, the buyer 110 can speak the one-time payment code out loud and the seller 115 can enter the one-time payment code in the second hub 215. Additionally or alternatively, the second hub 215 can include an input that allows the buyer 110 to enter the code into the second hub 215. One of skill in the art will appreciate that any method of transferring the one-time payment code from the first hub 205 to the second hub 215 whether now known or developed in the future is contemplated within the scope of the invention. Because the one-time payment code can only be used to authorize a single payment, the dangers of having the code stolen are minimized. At most, the code could be used only a single time and for a purchase price exactly matching the purchase prices of the items being purchased by the buyer 110.

FIG. 2 shows that the second hub 215 can also interact with the seller. For example, the second hub 215 can receive from the seller a description of the items to be purchased and/or the total purchase amount. For example, the second hub 215 could include a cash register, either mechanical or digital, that totals the purchases of the buyer 110 and presents a total to the seller 115 to be charged the user. Additionally or alternatively, the second hub 215 can also confirm to the seller 115 that the funds have been received, thus enabling the seller 115 to relinquish the sold goods.

In at least one implementation, the second hub 215 is not able to interact directly with the code generator 210. This can ensure that the second hub 215 is not able to access any of the buyer's 110 financial information. In particular, the buyer's financial information is stored by the code generator 210 and cannot be accessed via the second hub 215 because the second hub 215 is unable to interact directly with the code generator 210.

FIG. 2 also shows that the system 200 can include a payment engine 220. In at least one implementation, the payment engine 220 can confirm the authenticity of the one-time payment code. In particular, confirming the authenticity of the one-time payment code can include determining whether the one-time payment code is a validly issued one-time payment code. Additionally or alternatively, confirming the authenticity of the one-time payment code can include determining whether the one-time payment code has expired.

One of skill in the art will appreciate that the code generator 210 and the payment engine 220 can include separate entities. Additionally or alternatively the code generator 210 can be a sub-element of the payment engine 220 or that the payment engine 220 can be a sub-element of the code generator 210. Additionally or alternatively, the code generator 210 and the payment engine 220 can be separate elements of a larger structure. One of skill in the art will also appreciate that the code generator 210 can perform the functions of the payment engine 220 or vice versa without restriction.

In at least one implementation, once the authenticity of the one-time payment code has be confirmed, the payment engine 220 transfers the funds for any necessary payment from the buyer 110 to the seller 115. In particular, the payment engine 220 transfers funds from an account specified by the buyer 110 to an account specified by the seller 115. The payment occurs without the exchange of financial information between the buyer 110 and the seller 115, as discussed above.

FIG. 2 shows that the payment engine 220 can interact with the second hub 215. In at least one implementation, the second hub 215 can transmit the one-time payment code to the payment engine 220 for authentication. Additionally or alternatively, the payment engine 220 can transmit a confirmation that the payment has been made to the second hub 215 to inform the seller 115 that payment has been received.

FIG. 2 shows that the payment engine 220 can interact with the code generator 210. In at least one implementation, the interaction can allow the payment engine 220 to determine whether the one-time payment code remains valid. For example, the payment engine 220 can query the code generator 210 as to whether the one-time payment code was validly issued and as to what time the one-time payment code was issued, to ensure that the one-time payment code has not expired.

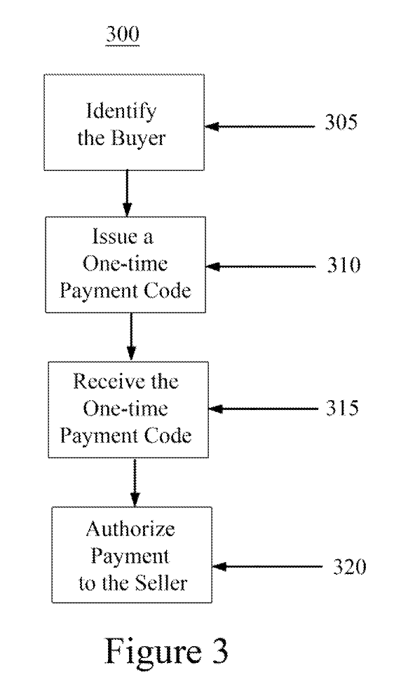

FIG. 3 is a flow chart illustrating a secure payment method 300. In at least one implementation, the secure payment method 300 can allow for a purchase to be completed without any exchange of payment information or money tender details. In particular, no financial information need be exchanged between different parties, other than a one-time payment code that is good for only the purchase amount and valid only for a limited time, as discussed above. One of skill in the art will appreciate that the method 300 can be used by the system 100 of FIG. 1; however, the method 300 can be used by a system other than the system 100 of FIG. 1.

FIG. 3 shows that the method 300 includes identifying the buyer 305. In at least one implementation, identifying the buyer 305 includes confirming the buyer's identity. In particular, confirming the buyer's identity can prevent fraud or unauthorized transactions involving the buyer's account. Confirming the buyer's identity can allow the buyer to complete a financial transaction without carrying payment mechanisms such as credit cards, checks, cash, debit cards, gift cards or any other payment mechanism. Additionally or alternatively, identifying the buyer 305 can include determining whether the buyer has sufficient funds in a buyer account to cover the purchase amount.

In at least one implementation, the buyer can have different access rights to the buyer account. For example, the buyer can be allowed to spend only a portion of the funds in a buyer account. Additionally or alternatively, the buyer can have restricted access to the balance of spending statements of the buyer account. This can allow for gifts or transfers to the buyer while limiting the purchasing power of the buyers. In particular, allowances, expense accounts, gifts or other portions of a larger buyer account can be provided for spending by the buyer.

In at least one implementation, identifying the buyer 305 can include interacting with the buyer in order to confirm the buyer's identity. For example, identifying the buyer 305 can include confirming the buyer's identity through biometric identification. Biometric identification, or biometrics, comprises methods for uniquely recognizing individuals based upon one or more intrinsic physical or behavioral traits, as discussed above. Additionally or alternatively, identifying the buyer 305 can include confirming the buyer's identity using one or more implants in or on the buyer's body, as discussed above.

In at least one implementation, identifying the buyer 305 can include the use of a personal buyer hub. A personal buyer hub is one that is linked to an account of a single buyer. That is, a personal buyer hub is linked to a specific buyer account or accounts. For example, a personal buyer hub could include a user's cell phone, computer or other device used only by a single buyer or group of buyers. Additionally or alternatively, a personal buyer hub could include a secure website that the user can log into from any location. The personal buyer hub can also include a hub that can be used by a group of users. For example, a personal buyer hub can include a computer in a secure location that a corporation's employees can access, allowing select employees to make payments in behalf of the corporation.

In contrast, identifying the buyer 305 can include the use of a shared buyer hub. A shared buyer hub is one that can be used by more than one buyer. In at least one implementation, a shared buyer hub can be installed in or near a site maintained by the seller to speed and facilitate transaction processing from multiple buyers. The buyer is authenticated on the shared buyer hub prior to a request for the transaction on the buyer's account.

FIG. 3 shows that the method 300 can also include issuing a one-time payment code 310. In at least one implementation, the one-time payment code can include a unique authorization code that can only be used once by the seller to collect payment from the buyer. For example, after the one-time payment code is used it cannot be used again by the buyer or by anyone else. Additionally or alternatively, the one-time payment code can be configured to expire after a certain amount of time after it issues if it has not been used during that time.

FIG. 3 further shows that the method 300 can also include receiving the one-time payment code 315. In at least one implementation, the one-time payment code has been received by the buyer and transmitted to the seller, who is submitting the one-time payment code. After the one-time payment code has been received the authenticity of the one-time payment code can be confirmed. In particular, confirming the authenticity of the one-time payment code can include determining whether the one-time payment code is a validly issued one-time payment code. Additionally or alternatively, confirming the authenticity of the one-time payment code can include determining whether the one-time payment code has expired.

FIG. 3 shows that the method 300 also includes authorizing payment to the seller 320. In at least one implementation, once the authenticity of the one-time payment code has been confirmed, the funds for any necessary payment can be transferred from the buyer to the seller. In particular, funds can be transferred from an account specified by the buyer to an account specified by the seller. The payment occurs without the exchange of financial information between the buyer and the seller, as discussed above.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

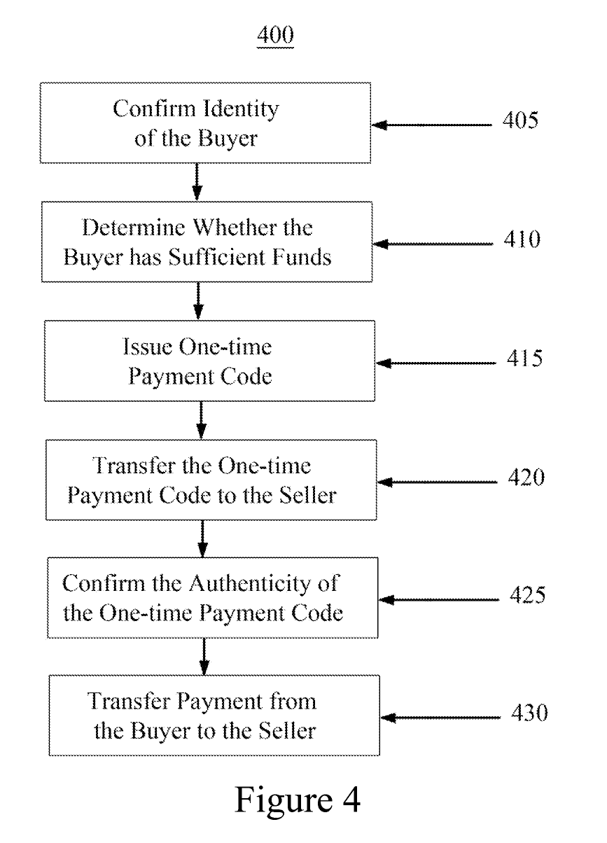

FIG. 4 is a flow chart illustrating an alternative secure payment method 400. In at least one implementation, the secure payment method 400 can allow for a purchase to be completed without any exchange of payment information or money tender details. In particular, no financial information need be exchanged between different parties, other than a one-time payment code that is good for only the purchase amount and valid only for a limited time, as discussed above.

FIG. 4 shows that the method 400 includes confirming the identity of the buyer 405. In particular, confirming the buyer's identity can prevent fraud or unauthorized transactions involving the buyer's account. Confirming the buyer's identity can allow the buyer to complete a financial transaction without carrying payment mechanisms such as credit cards, checks, cash, debit cards, gift cards or any other payment mechanism. In at least one implementation, confirming the identity of the buyer 405 can include interacting with the buyer in order to confirm the buyer's identity. For example, identifying the buyer 405 can include confirming the buyer's identity through biometric identification. Biometric identification, or biometrics, comprises methods for uniquely recognizing humans based upon one or more intrinsic physical or behavioral traits, as discussed above. Additionally or alternatively, confirming the identity of the buyer 405 can include confirming the buyer's identity using one or more implants in or on the buyer's body, as discussed above.

In at least one implementation, confirming the identity of the buyer 405 can include the use of a personal buyer hub. A personal buyer hub is one that is linked to an account of a single buyer. That is, a personal buyer hub is linked to a specific buyer account or accounts. For example, a personal buyer hub could include a user's cell phone, computer or other device used only by a single buyer or group of buyers. Additionally or alternatively, a personal buyer hub could include a secure website that the user can log into from any location. The personal buyer hub can also include a hub that can be used by a group of users. For example, a personal buyer hub can include a computer in a secure location that a corporation's employees can access, allowing select employees to make payments in behalf of the corporation.

In contrast, confirming the identity of the buyer 405 can include the use of a shared buyer hub. A shared buyer hub is one that can be used by more than one buyer. In at least one implementation, a shared buyer hub can be installed in or near a site maintained by the seller to speed and facilitate transaction processing from multiple buyers. The buyer is authenticated on the shared buyer hub prior to a request for the transaction on the buyer's account.

FIG. 4 also shows that the method 400 includes determining whether the buyer has sufficient funds 410. In at least one implementation, determining whether the buyer has sufficient funds 410 includes determining whether the purchase amount is less than the amount in a linked account. For example, the linked account can include a saving's account or a checking account. Additionally or alternatively, determining whether the buyer has sufficient funds 410 can include determining whether the buyer has sufficient credit to cover the purchase. For example, a credit card, line of credit, or other credit mechanism can be checked for sufficient credit to make the purchase.

In at least one implementation, the buyer can have different access rights to the buyer account. For example, the buyer can be allowed to spend only a portion of the funds in a buyer account. Additionally or alternatively, the buyer can have restricted access to the balance of spending statements of the buyer account. This can allow for gifts or transfers to the buyer while limiting the purchasing power of the buyers. In particular, allowances, expense accounts, gifts or other portions of a larger buyer account can be provided for spending by the buyer.

FIG. 4 further shows that the method 400 can include issuing a one-time payment code 415. In at least one implementation, the one-time payment code can include a unique authorization code that can only be used once by the seller to collect payment from the buyer. For example, after the one-time payment code is used it cannot be used again by the buyer or by anyone else. Additionally or alternatively, the one-time payment code can be configured to expire after a certain amount of time after it issues if it has not been used during that time.

FIG. 4 also shows that the method 400 can include transferring the one-time payment code to the seller 420. For example, the buyer could broadcast the one-time payment code and the seller could receive the broadcast. The broadcast can occur over a network either wired or wireless. For example, the one-time payment code could be sent of a network, over the Internet, over a telephone network, sent in an email or SMS text message or could be broadcast in any other manner. Additionally or alternatively, the buyer can speak the one-time payment code out loud and the seller can enter the one-time payment code in the second hub. Additionally or alternatively, the buyer can input the code directly into a device controlled by the seller. Because the one-time payment code can only be used to authorize a single payment, the dangers of having the code stolen are minimized. At most, the code could be used only a single time and for a purchase price exactly matching the purchase prices of the items being purchased by the buyer.

FIG. 4 further shows that the method 400 can include confirming the authenticity of the one-time payment code 425. In particular, confirming the authenticity of the one-time payment code 425 can include determining whether the one-time payment code is a validly issued one-time payment code. Additionally or alternatively, confirming the authenticity of the one-time payment code 425 can include determining whether the one-time payment code has expired.

FIG. 4 also shows that the method 400 can include transferring payment from the buyer to the seller 430. In at least one implementation, once the authenticity of the one-time payment code has been confirmed, the funds for any necessary payment can be transferred from the buyer to the seller. In particular, funds can be transferred from an account specified by the buyer to an account specified by the seller. The payment occurs without the exchange of financial information between the buyer and the seller, as discussed above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for facilitating a financial transaction without any exchange of payment information or money tender details between a buyer and a seller, the method comprising:
identifying the buyer, wherein identifying the buyer includes confirming the buyer's identity;
issuing a one-time payment code to the buyer;
receiving the one-time payment code from a seller, wherein the one-time payment code has been transferred from the buyer to the seller; and
authorizing payment to the seller.

2. The method of claim 1, wherein confirming the buyer's identity includes biometric identification.

3. The method of claim 2, wherein biometric identification includes one of:
fingerprint confirmation;
face recognition;
DNA;
palm print;
hand geometry;
iris recognition;
odor recognition; or
retina scan.

4. The method of claim 2, wherein biometric identification includes one of:
typing rhythm;
gait; or
voice recognition.

5. The method of claim 1, wherein confirming the buyer's identity includes logging the user into a secure website.

6. The method of claim 1, further comprising invalidating the one-time payment code when not used within a certain time period.

7. The method of claim 1, further comprising marking the one-time payment code as invalid after it is received from the seller.

8. A system for facilitating a financial transaction without any exchange of payment information or money tender details between a buyer and a seller, the system comprising:
a first hub, wherein the hub is configured to identify the buyer;
a code generator, wherein the code generator authorizes the payment and issues a one-time payment code to the first hub;
a second hub, wherein the second hub accepts the one-time payment code from the first hub; and
a payment engine, wherein the payment engine verifies the one-time payment code and authorizes payment.

9. The system of claim 8, wherein the first hub transmits the one-time payment code to the second hub wirelessly.

10. The system of claim 8, wherein the first hub is a cell phone.

11. The system of claim 8, wherein the first hub is a computer.

12. The system of claim 8, wherein the first hub is a personal buyer hub, wherein the personal buyer hub is configured to:
be used by only a single buyer.

13. The system of claim 8, wherein the first hub is a shared buyer hub, wherein the shared buyer hub is configured to:
be used by multiple buyers.

14. The system of claim 0, wherein the shared buyer hub is located at the seller's place of business.

15. A method for facilitating a financial transaction without any exchange of payment information or money tender details between a buyer and a seller:
confirming the identity of the buyer;
determining whether the buyer has sufficient funds in a buyer account to cover the purchase amount;
issuing a one-time payment code to the buyer if the buyer has sufficient funds;
transferring the one-time payment code to the seller;
confirming the authenticity of the one-time payment code, wherein confirming the authenticity of the one-time payment code includes:
determining whether the one-time payment code is a validly issued one-time payment code; and
determining whether the one-time payment code has expired; and
transferring payment to the seller, wherein transferring funds to the seller includes:
crediting the purchase amount to the seller; and
debiting the purchase amount from the buyer.

16. The method of claim 16, wherein the buyer account includes one of :
a savings account;
a credit card;
a debit account;
a line of credit; or
a checking account.

17. The method of claim 16, wherein the method further comprises:
issuing a notice to the buyer that the one-time payment code has been used.

18. The method of claim 15, further comprising:
invalidating the one-time payment code when not used within a certain time period.

19. The method of claim 16, further comprising:
invalidating the one-time payment code after it is received from the seller.

20. The method of claim 16, further comprising:
connecting the buyer to a code generator over a first network; and
connecting the seller to a payment engine over a second network.
